(19) United States
(12) Patent Application Publication
(10) Pub. No.: US 2011/0081461 A1
(43) Pub. Date: Apr. 7, 2011

(54) WAFFLE CHIPS

(76) Inventors: BRENT JOHNSON, Knob Noster, MO (US); Elizabeth Johnson, Knob Noster, MO (US)

(21) Appl. No.: 12/572,977

(22) Filed: Oct. 2, 2009

(51) Int. Cl. A21D 13/08; A23P 1/00; A23G 3/00

(52) U.S. Cl. 426/139; 426/391

(57) ABSTRACT

The present invention relates to a waffle chip to complement and aid in the consumption of frozen desserts and the method of making the same. The waffle chip according to the present invention includes: a top side; a curved bottom side; two angled sides, where the two angled sides connect the top side to the bottom side; and a concaved underside, where said concaved underside provides a mechanism to scoop and contain the frozen dessert. The waffle chip includes a waffle type pattern across the surface and the concaved underside creates a spoon-like shape. In one particular embodiment, the waffle chip may be 3 inches in length.

### BACKGROUND OF THE INVENTION

1. Field of Invention

The present invention relates to waffle chips to use in providing a scoop-type utensil to enjoy frozen desserts such as ice cream, frozen yogurt or frozen custard.

2. Description of Related Art

Desserts for some individuals are the most enjoyable course of a meal. Desserts are usually served at the end of the meal after the entrée or main course. The dessert usually comprises a sweet food such as cakes, cookies, fruits, pastries, ice creams and/or puddings. Many desserts may be eaten with a spoon however ice cream and other frozen desserts may be served on a cone-shaped pastry.

The ice cream cone is usually made of a wafer with a similar texture as a waffle. The ice cream is stacked and/or packed into the cone and the cone is held in the individual's hands for consumption. Specific types of ice cream cones include waffle, cake, pretzel and sugar cones. The ice cream cone is normally shaped in a cone shape however some cones have a flat bottom where they may be actually set down and placed upright similar to a cup while other cones remain conical. Larger waffle cones include wider openings for the insertion of greater amounts of ice cream. Ice cream cones provide an alternative serving means for frozen desserts as opposed to a bowl or cup.

The ice cream cone has remained in its traditional shape and configuration over many years. Although the waffle cone is similar to a waffle in texture and consistency, little variation has been developed with respect to the use of the waffle-style ice cream cone. Some variations have been developed with respect to the shape in cooking appliances associated with waffles but the combination of unique shapes for ice cream cones has not been developed.

It would be advantageous to have an alternative means to enjoy frozen desserts as opposed to serving in a bowl or enjoying an ice cream cone. It would be further advantageous to use a cone-type pastry to serve and enjoy frozen desserts thereupon.

### SUMMARY OF THE INVENTION

The present invention relates to a waffle chip to complement and aid in the consumption of frozen desserts and the method of making the same. The waffle chip according to the present invention includes: a top side; a curved bottom side; two angled sides, where the two angled sides connect the top side to the bottom side; and a concaved underside, where said concaved underside provides a means to scoop and contain the frozen dessert. The waffle chip includes a waffle type pattern across the surface and the concaved underside creates a spoon-like shape. In one particular embodiment, the waffle chip may be 3 inches in length.

### BRIEF DESCRIPTION OF DRAWINGS

FIG. 1 depicts a waffle chip according to the present invention.

### DETAILED DESCRIPTION

The present invention relates to a waffle chip that is configured and designed to scoop and serve frozen desserts such as ice cream, frozen yogurt or custard in a manner where the waffle chip is used to scoop the dessert from a serving dish. The waffle chip according to the present invention has a spoon-like shape and is therefore readily available to enjoy ice cream or other frozen dessert. The waffle chip can be used to scoop and dip into the frozen dessert and allow the user to enjoy the dessert with the waffle chip or enjoy the ice cream alone while using the waffle chip. The waffle chip according to present invention provides a small scoop and therefore obviates the need for a spoon or other utensil to enjoy ice cream served in a bowl. Further the waffle chip may be consumed along with the ice cream and therefore multiple waffle chips may be utilized to enjoy a single bowl of ice cream.

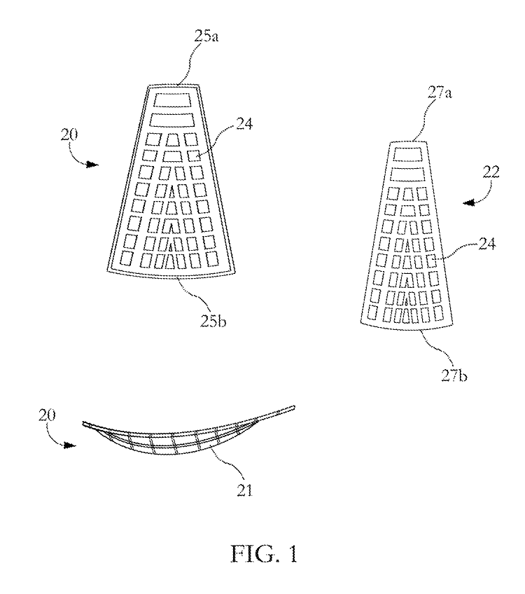

FIG. 1 depicts a waffle chip 20 according to the present invention. The waffle chip 20 according to the present invention includes a chip that has a concaved underside 21 with a waffle-type pattern 24 across the surface thereof. The waffle chip 20 is comprised of four sides. The topside 25a is substantially straight and the bottom side 25b is somewhat curved and has a longer length than the topside 25a. Two sides connect the topside 25 to the bottom side 25b and run at a diverging angle from the topside 25a to the curve bottom side 25b. The waffle chip according to present invention has a shape similar to a triangle however the waffle chip maintains four sides. An alternative waffle chip 22 is also depicted in FIG. 1. The waffle chip 22 maintains the substantially curved underside 21 as waffle chip 20. The curved underside 21 provides a means to scoop and hold the frozen dessert within the chip while consuming. The alternative waffle chip 22 is somewhat smaller than the waffle chip 20 also depicted in FIG. 1. The waffle chip 22 also includes a topside 27a and a curved bottom side 27b with the two connecting sides.

The waffle chip 20, 22 may be grasped at any corner of the chip when being used. The waffle chip 20, 22 provides a substitute for a utensil while enjoying a frozen desert out of a bowl. More so the waffle chip provides a delightful treat that can be included with the desert. The waffle chip may be made of similar materials and substances as the traditional ice cream cone however has been configured in a manner where it resembles a spoon or scooping-type utensil. The small scoop that the waffle cone 20, 22 provides insures that the consumer may enjoy both waffle and ice cream with each bite of their dessert. In one particular embodiment of the present invention, the waffle chip may be approximately three inches in length and a plurality of chips may be served to the consumer.

The waffle chip according to the present invention may be provided to the consumer in its final form, or as an alternative, a waffle-cutting tool and iron may be provided so that a user may create their own waffle chips using a standard waffle iron. The home creation of the waffle chip according to the present invention includes providing a waffle iron shaped in the manner to create a waffle chip as depicted in FIG. 1. Thus the waffle iron may include grouping of four sided concaved irons for the use with a traditional waffle iron. Furthermore once the iron configures the grouping of waffle chips these chips may be cut and sliced for use by the consumer. In one particular embodiment, the waffle iron associated with the waffle chip according to the present invention may be able to produce up to 16 chips per mold.

The waffle chip 20, 22 according to the present invention provides an alternative for the enjoyment of frozen desserts as opposed to using a bowl and utensil or a conventional ice cream cone. This unconventional manner of consuming frozen desserts creates a unique and enjoyable experience for one's dessert. The waffle chips according to present invention are also durable enough to be utilized with various consistencies of ice cream and therefore are a very practical substitute for a utensil.

What is claimed is:

1. A waffle chip to complement and aid in the consumption of frozen desserts comprising:
a. a top side;
b. a curved bottom side;
c. two angled sides, where the two angled sides connect the top side to the bottom side; and
d. a concaved underside, where said concaved underside provides a means to scoop and contain the frozen dessert.

2. The waffle chip according to claim 1, where the waffle chip includes a waffle type pattern across the surface.

3. The waffle chip according to claim 1, where the concaved underside creates a spoon-like shape.

4. The waffle chip according to the claim 1, where said chip is 3 inches in length.

5. A method of making a waffle chip comprising the steps of:
a. providing a waffle iron, where said iron includes a grouping of molds, where each mold is configured with a top side, a curved bottom side, two angled sides and a concaved surface;
b. inserting batter into the waffle iron;
c. heating the waffle iron a predetermined period of time;
d. removing the grouping of waffle chips from the waffle iron; and
e. cutting individual waffle chips from the group.

6. The method of making a waffle chip according to claim 5, where said grouping of molds produce up to 16 waffle chips.
